(19) United States
(12) Patent Application Publication
(10) Pub. No.: US 2016/0092940 A1
(43) Pub. Date: Mar. 31, 2016

(54) DE-DUPLICATING COMBINED CONTENT

(71) Applicant: Linkedln Corporation, Mountain View, CA (US)

(72) Inventors: Ankit Gupta, Campbell, CA (US); Hailin Wu, Palo Alto, CA (US); Ramakrishna Vemuri, Fremont, CA (US); Sanjay Kshetramade, Fremont, CA (US)

(21) Appl. No.: 14/501,829

(22) Filed: Sep. 30, 2014

(51) Int. Cl. G06Q 30/02

(52) U.S. Cl. CPC G06Q 30/0277

(57) ABSTRACT

A system, method, and apparatus for de-duplicating and serving a combined content feed are provided. The combined content includes items of two or more classes, such as sponsored and unsponsored, wherein some or all unsponsored content items may be sponsored. A feed service obtains sponsored and unsponsored items suitable for a user to whom the combined content feed is to be served. The service determines whether an item is duplicated among the multiple classes. If so, a distance between the duplicates is calculated (within the feed). If the distance is less than a first threshold, one of them is discarded and may or may not be replaced. A decision regarding which to eject may depend upon which version (e.g., sponsored or unsponsored) is positioned earlier in the feed, whether the duplicates are also less than a second threshold apart (which is lower than the first threshold), and/or other factors.

### BACKGROUND

This disclosure relates to the field of computer systems. More particularly, a system, apparatus, and methods are provided for de-duplicating combined content items served to a user.

In a system that serves or presents multiple classes of content (e.g., sponsored and unsponsored, content having different formats), any given content item may be served or recommended for serving via both classes. This action may cause a user to receive two copies of the item, may cause fatigue regarding that item and, in general, may diminish his or her experience.

### DESCRIPTION OF THE FIGURES

FIG. 1 is a block diagram depicting a system for serving combined content, in accordance with some embodiments.

FIG. 2 is a flow chart illustrating a method of eliminating duplicates among combined content, in accordance with some embodiments.

FIG. 3 depicts an apparatus for serving combined content, in accordance with some embodiments.

### DETAILED DESCRIPTION

The following description is presented to enable any person skilled in the art to make and use the disclosed embodiments, and is provided in the context of one or more particular applications and their requirements. Various modifications to the disclosed embodiments will be readily apparent to those skilled in the art, and the general principles defined herein may be applied to other embodiments and applications without departing from the scope of those that are disclosed. Thus, the invention or inventions associated with this disclosure are not intended to be limited to the embodiments shown, but rather is to be accorded the widest scope consistent with the disclosure.

In some embodiments, a system, apparatus, and methods are provided for efficiently serving or presenting combined content. In these embodiments, combined content includes both sponsored content and unsponsored content, the latter of which may alternatively be termed organic or native content. In these embodiments, sponsored content includes content that a sponsor pays to have served to users (e.g., advertisements, job opportunities, other content that a sponsor wishes to have distributed), while unsponsored content includes content that is freely distributed (i.e., without cost) and which may be generated by the system or apparatus and/or by users of the system or apparatus.

For example, as implemented within a professional or social networking environment, combined content served to a given user may include not only organic content items related to that user and to friends and/or associates of the user (i.e., unsponsored content), but also items that some entity is paying to have distributed (i.e., sponsored content).

Individual content items may include news articles, stories, opinions, messages, comments, images, video, job descriptions, résumés, social posts, and so on, as well as activities (or notifications of activities) such as likes, dislikes, recommendations, endorsements, new associations between users, etc.

When combined content is to be served to a user, some number of sponsored content items and some number of unsponsored content items are solicited from corresponding services that suggest, identify, and/or provide such items. The items selected for serving are ordered or prioritized and, in some implementations, are presented to the user as an ongoing or renewal feed.

For example, a relatively large total number of sponsored and unsponsored content items (e.g., 100, 200) may be identified and ordered, but only relatively small subsets or partitions of the feed may be transmitted or delivered to the user (e.g., an electronic device operated by the user) at a time. As he or she consumes the content (e.g., by scrolling through the items), additional subsets or partitions may be delivered and presented. New feeds may be assembled when the user navigates to a new page, refreshes the current page, or some other action occurs.

In embodiments described herein, a given content item may be able to be served as both a sponsored item and an unsponsored item, and the system or apparatus for serving or presenting the combined content reduces or eliminates duplication of an item within a feed. If duplicate items are identified for inclusion in a feed, one or both of them may be removed from the feed, depending on which would be presented earlier in the feed, the distance between them, and/or other factors.

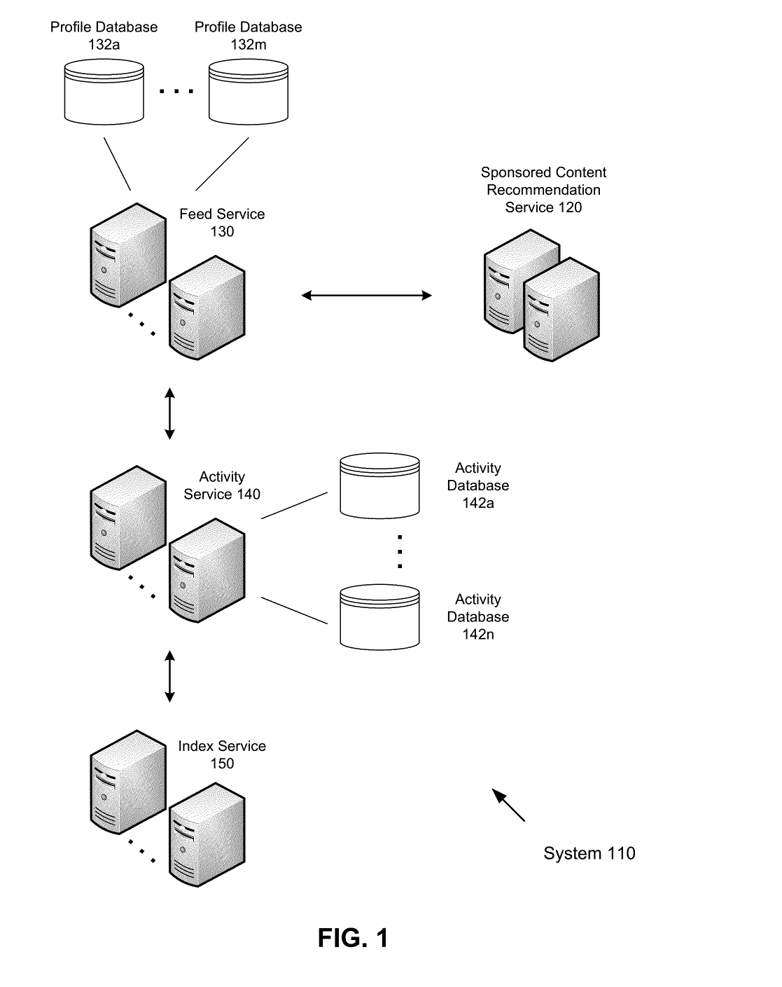

FIG. 1 is a block diagram of an illustrative system for serving combined content, according to some embodiments. System 110 may be implemented as or within a data center or other computing system operated by an online service, such as an online professional social networking service. Although these embodiments of the system are described as they are implemented for combined content that comprises sponsored and unsponsored content items, in other embodiments other classes of content may be combined and require de-duplication in manners similar to those described herein.

Users of a service offered by system 110 connect to the system (e.g., to a feed server 130, to a portal server) via client devices, which may be stationary (e.g., a desktop computer, a workstation) or mobile (e.g., a smart phone, a tablet computer, a laptop computer). The client devices operate suitable client applications, such as a browser program or an application designed specifically to access the service(s) offered by system 110. Users of system 110 may be termed members because they may be required to register with the system in order to fully access the system's services.

In some embodiments, members of a service hosted by system 110 have corresponding ‘home’ pages (e.g., web pages, content pages) that are accessible via the members' client applications, and that they may use to facilitate their activities with the system and their interactions with each other. In particular, these pages may be the initial pages the members ordinarily see when they visit a web site hosted by the system, and allow the members to view the content items selected by the system for display to them. With each connection, feed service 130 receives information identifying the member (e.g., user credentials, user ID), a type or platform of client device being used, a user agent, etc.

Content items served to a member via his or her home page and/or other pages (e.g., pages associated with other members, pages associated with particular activities or organizations) may include any of the plethora of classes and types of content and items described herein, and may be presented in frames, tabs, as a feed that is continually augmented, as additional pages linked to the initial page, etc. In addition, content items may be served to members via electronic mail, instant message, and/or other forms of electronic communication. Some or all content items served to a member, or considered for serving to the member, are subject to filtering to order the items appropriately, to remove inappropriate items, to eliminate duplicates, etc.

As will be described in more detail below, feed service 130 retrieves and feeds to the member multiple classes of content items, such as sponsored and unsponsored content, as introduced above. Both sponsored and unsponsored content may include the same types of content items and even one or more identical items. A primary differentiation between the two classes of content is that some entity (which may or may not be a member of a service of system 110) is paying to having each sponsored content item distributed.

Feed service 130 includes multiple computer servers, coupled to multiple profile databases 132 (e.g., 132a, 132m) that store information regarding members of system 110. An individual member's profile may reflect any number of attributes or characteristics of the member, including personal (e.g., gender, age or age range, interests, hobbies), professional (e.g., employment status, job title, functional area, employer, skills, endorsements, professional awards), social (e.g., organizations the user is a member of or affiliated with, geographic area or location, friends, associates), educational (e.g., degree(s), university attended, other training), etc.

Profiles (or attributes of a profile) are but one type of content that can be served by system 110. In particular, a content item served to a given member may include a portion of another member's profile. For example, when one member updates his or her profile (e.g., to add a photo, to report a new job, to reflect a new skill) associated members may be notified.

Organizations may also be members of a service offered by system 110, and have descriptions or profiles that include, in addition to or instead of applicable attributes enumerated above, attributes such as industry (e.g., information technology, manufacturing, finance), size, location, goal, owner(s), subsidiaries, etc. An “organization” may be a company, a corporation, a partnership, a firm, a government agency or entity, a not-for-profit entity, an online community (e.g., a user group), or some other entity formed for virtually any purpose (e.g., professional, social, educational).

Sponsored content recommendation service (or servers) 120 comprises one or more computer servers configured to identify or suggest sponsored content to serve to a given member. For example, based on one or more attributes of the member, service 120 searches one or more collections of sponsored content for items that are relevant to and/or likely to be of interest to the user. These items are identified to feed service 130 and some or all of them will be fed to the user. It should be noted that a given content item simultaneously may be a sponsored content item and an unsponsored content item. A given sponsored item may be sponsored by any member or an outside entity, and may be the same entity that created or made the item available as an unsponsored item (if it is also an organic content item) or a different entity.

Sponsored content recommendation service 120 may include or be coupled to an index of sponsored content, but the actual content may be stored elsewhere (e.g., in activity databases 142).

Activity service (or servers) 140 includes one or more computer servers configured to fetch specific content items (sponsored and/or unsponsored) from activity databases 142 (e.g., databases 142a, 142n) and pass them to the feed service for serving to users. Activity databases 142 store activities of the users of system 110, including status updates, uploaded/shared/newly created content (e.g., articles, documents, images, video, audio), comments, endorsements, “likes,” shares, profile updates (e.g., a new profile photo, a new skill), posts, messages, etc. In short, any action taken by a user of system 110 while connected to a system service may be captured as an activity and stored in an activity database.

When activities and/or other content is stored in activity databases 142, it may be stored with attributes, indications, characteristics, and/or other information describing one or more suitable or preferred audiences of the content. For example, a provider of a job listing may identify attributes of members that should be informed of the opening, an organization wishing to obtain more followers/subscribers/fans may identify the type(s) of members it would like to attract, a member seeking to make connections with other members having common attributes or characteristics (e.g., alma mater, home town) may post an announcement, and so on.

In some implementations, different activity databases store different types of content items (e.g., likes, shares, endorsements), and different servers within service 140 may be dedicated to retrieving or producing different types of items. Sponsored content items may be intermingled with unsponsored items, and may not be differentiated until the items are ordered for presentation, rendered within activity service 140 or feed server 130 (or elsewhere), or may not be differentiated at all within the content served to a user.

Index service (or servers) 150 comprises multiple servers that host and operate an index (or indexes) of the activities/items stored in activity databases 142. Therefore, in order to identify suitable (e.g., recommended) unsponsored content items for a given member, the index service (or activity service) may receive information regarding the member and use it to select some number (or a continuing stream) of individual items representing activities that are associated with and/or that may be of interest to the member.

Some or all content items within system 110 that can be or that are simultaneously both sponsored and unsponsored are stored within the activity databases. Such an item may therefore have a single identifier by which it is known and by which it is recommended or selected for inclusion as a sponsored item (e.g., by sponsored content recommendation server 120) and/or unsponsored item (e.g., by activity service 140).

As indicated above, in some embodiments feed service 130 and other components of system 110 operate to assemble a “feed” or stream of content items to deliver to a member or user of a service offered by the system. In these embodiments, the feed service solicits relevant content from services 120 and 140, receives items they identify, merges them into a feed, and dispatches the feed toward the member.

In some specific implementations, some or all of the items are ordered according to a calculated or estimated relevance to the member, and items of different classes (e.g., sponsored, unsponsored) are intermingled in some fashion. Thus, feed service 130 may request X items (X≧1) from sponsored content recommendation service 120, and may identify their absolute or relative positions within the feed (or such positions may be chosen by the sponsored content recommendation service). The sponsored content recommendation service then uses its recommendation logic to select X suitable items, and may order them according to their relevance, the likelihood that the member will interact with them, and/or other factors.

If the feed service is assembling a feed of 20 content items, for example, it may request 3 items from service 120 and identify their positions or slots within the feed (e.g., 3, 10, 18). The feed service would also request a corresponding number of items (e.g., 17) from activity service 140. Each of services 120, 140 will proffer the requested number of items, possibly ordered in terms of their perceived relevance or interest to the member. The feed service may repeatedly request additional content items if/as the user consumes (e.g., views) the entire previous feed.

Alternatively, and as described above, a feed may be relatively large (e.g., 100 items, 200 items, 300 items), and may be delivered in relatively small portions or subsets (e.g., each having 20 items) until the user stops viewing the items or a new feed must be assembled.

In order to limit or prevent duplication of content items within a feed, either or both of services 120, 140/140 will ensure that the items of the class that they recommend (e.g., sponsored, unsponsored) do not include duplicates. Further, feed service 130 will examine the items recommended by the services for duplication between classes. If a given item is included in both sets of recommendations, it will determine whether to discard one and, if one is to be discarded, will choose one to discard. Alternatively, it may change the ordering of items in a feed to provide for suitable distance between duplicates.

In some embodiments, one or more computer server devices depicted as hosting particular services may be replaced with hardware or software modules executing on a common computing device, as virtual computers for example.

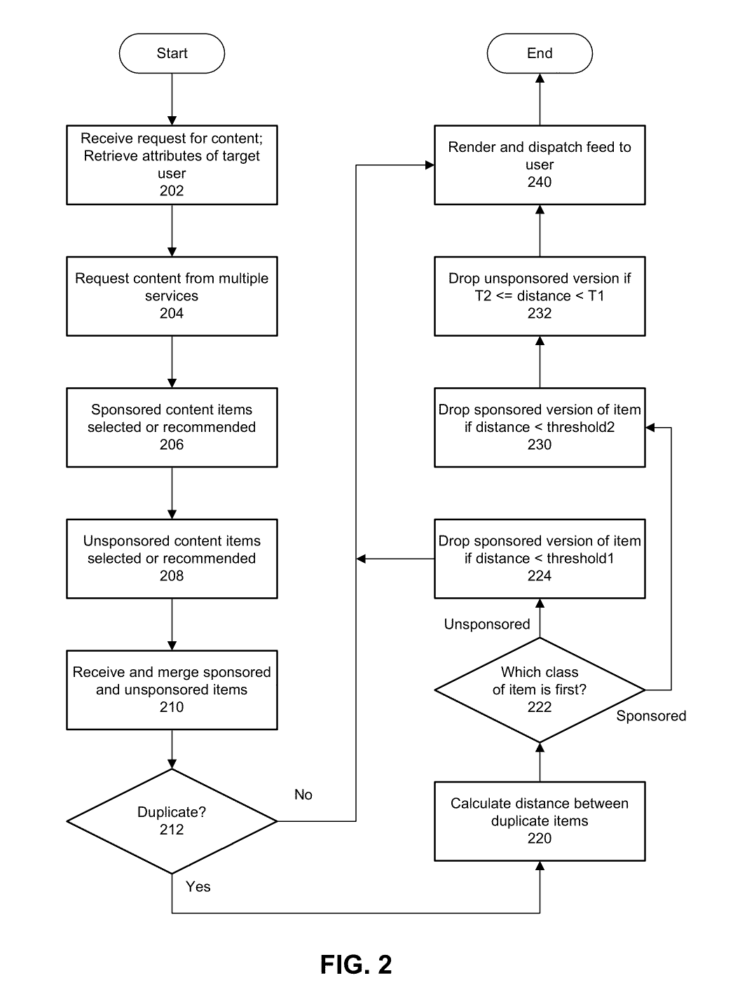

FIG. 2 is a flow chart demonstrating a method of handling duplicate items within combined content, according to some embodiments. In particular, these embodiments address duplication of an item among different classes of content, such as sponsored and unsponsored. Similar methods may be applied for content items that may be simultaneously assigned to other classes, such as attributed and unattributed content, content of different values, content from different sources, etc. Also, in some embodiments, some of the following operations may be merged, divided, omitted, or performed in a different order, and/or additional operations may be performed.

In operation 202, a request for content is received. Illustratively, this request may be in the form of a notification that a user or member has navigated to her home page (or some other page hosted by or associated with the same system, service, or application). A feed server receives the request or otherwise recognizes a need to assemble a content feed for the user, and may also receive a user ID or some other information that identifies or characterizes the user.

In addition, the feed server receives or obtains pertinent attributes of the user to whom the combined content feed will be served. These attributes may depend upon the type of content served by the system. For a professional social networking system, for example, the attributes may include (but are not limited to) identities of the user's contacts (e.g., first degree, second degree, friends, associates), current position or job, skills, employer, endorsements, location, gender, age range, education, companies the user follows, members the user has blocked, content preferences, connection type (e.g., mobile device, tablet computer), a status (e.g., job-seeker, newly hired) and so on.

In operation 204, the feed server issues requests for content items from which the user's feed will be assembled. In the illustrated embodiments, this involves requests for sponsored content (e.g., to sponsored content recommendation service 120 of FIG. 1) and for unsponsored content (e.g., to activity service 140 or index service 150 of FIG. 1).

Along with the requests, the feed server may provide information that may help the services identify suitable content—such as some or all of the user attributes obtained in operation 202, a number of content items needed, priorities (or rankings or relevance levels) of the requested content, specific slots (i.e., positions in the feed) that a service should fill, etc. For example, the feed server may identify the ordinal or priority numbers of content slots to be filled by a service, or simply a total number of slots.

In some implementations, a content feed assembled in response to a content request may include approximately 200 items, with about 10-20% of them being sponsored content items and the rest being unsponsored items. Although only a subset of the entire feed may be delivered to the user's device at a time (e.g., 10, 15, 20), additional subsets are delivered as needed, and an entire new feed may be generated if the first is exhausted, if the user refreshes her current page, or if she navigates to a new page that features the feed.

In operation 206, the sponsored content recommendation service executes a set of recommendation logic to identify a number of sponsored content items at least equal to the number requested by the feed server. The items may be identified by URN (Universal Resource Name), URI (Uniform Resource Identifier), URL (Uniform Resource Locator), or some other identifier. Selected sponsored content items that are (or can) also be served as unsponsored items may be identified by identifiers used by a central content storage service (e.g., activity service 140 of FIG. 1), while sponsored items that are not available for serving as unsponsored items (e.g., advertisements) may be stored with the sponsored content recommendation service or elsewhere.

The selected sponsored content items may be identified to the feed server with specified or suggested priorities or index numbers within the feed that is being assembled. Alternatively, the feed server may order or prioritize the sponsored items.

In operation 208, an unsponsored content service (e.g., activity service 140) executes logic to identify a number of unsponsored content items at least equal to the number requested by the feed server. The items may be prioritized or ordered by relevance.

As discussed previously, a user activity service may manage content items reflecting one or more types of activities of users/members of the system—such as posts, shares, likes, uploads, status updates, profile updates, comments, skill endorsements, etc. In the illustrated embodiment in which combined content comprises sponsored and unsponsored classes of content, unsponsored content items may be of any type of activity, while sponsored items may include sponsored forms of the same activities and/or content other than user/member activity.

For example, when one member shares something with another member (e.g., a report, a status update), a content item is created that is considered unsponsored. If, however, one of those members (or some other member) sponsors that activity to promote wider circulation, it will also be available for selection as a sponsored content item.

Sponsored and/or unsponsored content items recommended for the member's feed may include or be accompanied by controls or metadata that will be served with the items. If the user acts upon an item (e.g., by clicking on it), the corresponding control or metadata will cause the system to be notified, thereby allowing it to track the user's activity.

In operation 210, the feed server receives content (or content item identifiers) from the sponsored and unsponsored content recommendation services. The items may be fully or partially ordered or prioritized in some fashion, or the feed server may perform (or complete) the ordering of the combined content. In some specific implementations, some or all content items are received with indications of specific positions or slots at which they are to appear in the feed, or perhaps some indication of the order in which they are to be delivered. For example, the sponsored content items may be earmarked for certain slots, while the unsponsored items are received with some ordering or prioritization and are interleaved around the slots occupied by sponsored items.

Also in operation 210, the feed server may augment content items as necessary, by retrieving and adding other data. For example, users' profile data may not be stored with the activity data, but may be required to fully populate some content items—such as by adding skills or a picture of a member referenced in an item. Profile data may be accessed directly by the feed server, or it may obtain such data through another system component (e.g., a profile server).

In operation 212, the feed server determines whether any sponsored content item in the feed duplicates an unsponsored item. In implementations in which member/user activities are stored together (e.g., in an activity service), this determination may involve comparing each sponsored item's identifier with identifiers of all the unsponsored items. If there are no duplicates, the method proceeds to operation 240; otherwise, the method continues at to operation 220.

In operation 220, the feed server calculates the distance between the duplicate content items, in terms of feed positions or slots.

In operation 222, of the two duplicate items, the feed server determines which class of content would appear first in the feed, a sponsored version of the item or an unsponsored version. If the first or earlier item is sponsored, the method advances to operation 230; otherwise, the method continues at operation 224.

In operation 224, the unsponsored version of the duplicate item appears earlier in the feed. If the distance from the unsponsored item to the sponsored duplicate is less than a first threshold T1 (e.g., 15, 25), the sponsored version is removed from the feed. The removed item's slot may be left unfilled which, in essence, advances all following items one position. Alternatively, the removed item may be replaced with another sponsored or unsponsored content item, or another item may be added at the end of the feed.

In different embodiments, T1 may differ and may be dynamic. In some embodiments, the first threshold differs from one user or member to another, perhaps based on a user preference, a history of the user (e.g., how many feed items she typically consumes, how often she interacts with a sponsored item), how desirous it is to provide a good viewing experience, and/or other factors. The more important it is to provide a good viewing experience, the greater the first threshold may be. Contrarily, to maintain or reduce the negative impact on revenue, a lower first threshold may be applied.

The first threshold may differ for a given user from one visit to another, from one web site or web page to another, may differ based on the sponsor, based on the source or originator of the item, and/or may differ based on other factors. After operation 224, the method advances to operation 240 or returns to operation 212 to check for another pair of duplicate items.

In operation 230, the sponsored version of the item appears first or earlier in the feed. In the illustrated embodiments, if the distance between the duplicate items is less than a second threshold T2, the sponsored version of the item is dropped and the feed may or may not be augmented, as described above, and then the method may advance directly to operation 240 or return to operation 212. In these embodiments, T2 is less than T1 (e.g., 5).

In operation 232, if the distance between the duplicate items is greater than (or equal to) the second threshold T2, but less than the first threshold T1, the unsponsored version of the item is dropped (and the feed may or may not be augmented with another item). If less impact to revenue (from dropping sponsored content items) is desired, T2 could be adjusted downward. Also, or alternatively, T2 could be dynamic and depend upon the user's preferences, past behavior (e.g., clicks more on unsponsored items or sponsored items), and/or other factors. After operation 232, the method continues at operation 240 or may return to operation 212 to check for other duplicates.

In operation 240, the feed server finalizes and dispatches the feed (or a portion of the feed) to an electronic device operated by the user. This operation may involve rendering and/or decorating an item prior to transmission of the feed items. In some implementations, content items are fully or partially rendered by the activity service and/or sponsored content recommendation service before they are delivered to the feed server. In other implementations, some or all rendering is performed at the feed server.

Some types of items may be nested, such as a comment on a share, a sharing of a skill endorsement, and so on. Therefore, to fully render a given item, data of different types may have to be retrieved and assembled for any items not fully assembled. The feed (or a portion or subset thereof) is then dispatched toward the user, possibly through a portal or front-end server (e.g., a web server, a data server).

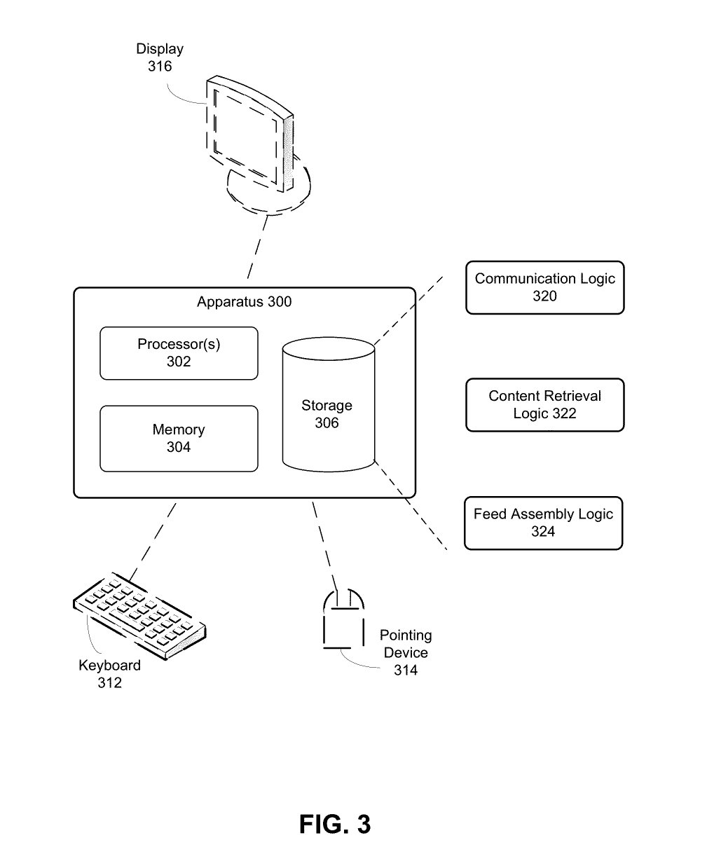

FIG. 3 is a block diagram of an apparatus for serving combined content and de-duplicating items as necessary, according to some embodiments.

Apparatus 300 of FIG. 3 includes processor(s) 302, memory 304, and storage 306, which may comprise one or more optical, solid-state, and/or magnetic storage components. Storage 306 may be local to or remote from the apparatus. Apparatus 300 can be coupled (permanently or temporarily) to keyboard 312, pointing device 314, and display 316. Multiple apparatuses 300 may operate in cooperation, such as in a load-balancing arrangement.

Storage 306 stores logic that may be loaded into memory 304 for execution by processor(s) 302. Such logic includes communication logic 320, content retrieval logic 322, and feed assembly logic 324. In other embodiments, any or all of these logic modules may be combined or divided to aggregate or separate their functionality.

Communication logic 320 comprises processor-executable instructions for communicating with other entities. For example, the communication logic may receive content feed requests, interact with other services (e.g., that provide and/or recommend content items), receive content, deliver feeds (or portions of feeds), etc.

Content retrieval logic 322 comprises processor-executable instructions for obtaining content items to assemble into a feed. As described above, for example, different classes of content (e.g., sponsored, unsponsored) may be solicited from different servers or services, and the items may be retrieved from one or more repositories. The items may be ordered by apparatus 300 (e.g., feed assembly logic 324), by the service or services that suggest or recommend content items, and/or the repository or repositories that store the items.

Feed assembly logic 324 comprises processor-executable instructions for assembling combined content—content items of multiple classes—into a feed to be delivered to a user or viewer. The feed assembly logic includes de-duplication logic for identifying and dealing with items duplicated in the multiple classes being assembled into the feed, or such logic may operate separately.

In some embodiments, apparatus 300 performs some or all of the functions ascribed to one or more components of system 110 of FIG. 1, such as feed service 130.

An environment in which some embodiments described above are executed may incorporate a general-purpose computer or a special-purpose device such as a hand-held computer or communication device. Some details of such devices (e.g., processor, memory, data storage, display) may be omitted for the sake of clarity. A component such as a processor or memory to which one or more tasks or functions are attributed may be a general component temporarily configured to perform the specified task or function, or may be a specific component manufactured to perform the task or function. The term “processor” as used herein refers to one or more electronic circuits, devices, chips, processing cores and/or other components configured to process data and/or computer program code.

Data structures and program code described in this detailed description are typically stored on a non-transitory computer-readable storage medium, which may be any device or medium that can store code and/or data for use by a computer system. Non-transitory computer-readable storage media include, but are not limited to, volatile memory, non-volatile memory, magnetic and optical storage devices such as disk drives, magnetic tape, CDs (compact discs) and DVDs (digital versatile discs or digital video discs), solid-state drives and/or other non-transitory computer-readable media now known or later developed.

Methods and processes described in the detailed description can be embodied as code and/or data, which may be stored in a non-transitory computer-readable storage medium as described above. When a processor or computer system reads and executes the code and manipulates the data stored on the medium, the processor or computer system performs the methods and processes embodied as code and data structures and stored within the medium.

Furthermore, the methods and processes may be programmed into hardware modules such as, but not limited to, application-specific integrated circuit (ASIC) chips, field-programmable gate arrays (FPGAs), and other programmable-logic devices now known or hereafter developed. When such a hardware module is activated, it performs the methods and processed included within the module.

The foregoing embodiments have been presented for purposes of illustration and description only. They are not intended to be exhaustive or to limit this disclosure to the forms disclosed. Accordingly, many modifications and variations will be apparent to practitioners skilled in the art. The scope is defined by the appended claims, not the preceding disclosure.

What is claimed is:

1. A computer-implemented method of de-duplicating combined content, the method comprising:
receiving a user connection at a content-serving system comprising one or more processors; and
operating the one or more processors to:
for each of multiple classes of content, obtain multiple content items;
determine a position of each of the obtained content items within a content feed to deliver to the user in response to the connection; and
for each obtained content item duplicated among the multiple classes:
calculate a distance, within the content feed, between the duplicate items; and
discard one of the duplicate items from the feed if the distance is less than a first threshold distance.

2. The method of claim 1, wherein the multiple classes of content include:
a sponsored class comprising sponsored content items; and
an unsponsored class comprising unsponsored content items.

3. The method of claim 2, wherein:
one duplicate item is sponsored and another duplicate item is unsponsored; and
said discarding comprises:
identifying which of the sponsored duplicate item and the unsponsored duplicate item appears earlier in the content feed than the other of the sponsored duplicate item and the unsponsored duplicate item;
discarding the sponsored duplicate item if:
the unsponsored duplicate item appears earlier and the distance is less than the first threshold; or
the sponsored duplicate item appears earlier and the distance is less than a second threshold that is less than the first threshold; and
discarding the unsponsored duplicate item if:
the sponsored duplicate item appears earlier, and the distance is greater than the second threshold and less than the first threshold.

4. The method of claim 3, wherein:
the first threshold is approximately 25; and
the second threshold is approximately 5.

5. The method of claim 2, wherein the first threshold varies according to the user.

6. The method of claim 2, wherein the first threshold varies according to a sponsor of the sponsored duplicate item.

7. The method of claim 2, wherein every unsponsored content item can be sponsored.

8. An apparatus for de-duplicating combined content, comprising:
one or more processors; and
a non-transitory memory storing instructions that, when executed by the one or more processors, cause the apparatus to:
receive a user connection;
for each of multiple classes of content, obtain multiple content items;
determine a position of each of the obtained content items within a content feed to deliver to the user in response to the connection; and
for each obtained content item duplicated among the multiple classes:
calculate a distance, within the content feed, between the duplicate items; and
discard one of the duplicate items from the feed if the distance is less than a first threshold distance.

9. The apparatus of claim 8, wherein the multiple classes of content include:
a sponsored class comprising sponsored content items; and
an unsponsored class comprising unsponsored content items.

10. The apparatus of claim 9, wherein:
one duplicate item is sponsored and another duplicate item is unsponsored; and
said discarding comprises:
identifying which of the sponsored duplicate item and the unsponsored duplicate item appears earlier in the content feed than the other of the sponsored duplicate item and the unsponsored duplicate item;
discarding the sponsored duplicate item if:
the unsponsored duplicate item appears earlier and the distance is less than the first threshold; or
the sponsored duplicate item appears earlier and the distance is less than a second threshold that is less than the first threshold; and
discarding the unsponsored duplicate item if:
the sponsored duplicate item appears earlier, and the distance is greater than the second threshold and less than the first threshold.

11. The apparatus of claim 10, wherein:
the first threshold is approximately 25; and
the second threshold is approximately 5.

12. The apparatus of claim 9, wherein the first threshold varies according to the user.

13. The apparatus of claim 9, wherein the first threshold varies according to a sponsor of the sponsored duplicate item.

14. The apparatus of claim 9, wherein every unsponsored content item can be sponsored.

15. A system for de-duplicating combined content, comprising:
a repository of content items;
a sponsored content recommendation module comprising a first non-transitory computer readable medium storing instructions that, when executed by a processor, cause the sponsored content recommendation module to identify multiple sponsored content items to include in a feed of combined content to deliver to a user;
an unsponsored content recommendation module comprising a second non-transitory computer readable medium storing instructions that, when executed by a processor, cause the unsponsored content recommendation module to identify multiple unsponsored content items to include in the feed of combined content to deliver to the user; and
a feed service module comprising a third non-transitory computer readable medium storing instructions that, when executed by a processor, cause the feed service module to:
identify positions of the sponsored content items and the unsponsored content items within the feed; and
if a sponsored content item and an unsponsored content item are duplicates:
determine a distance between the sponsored duplicate item and the unsponsored duplicate item; and
discard one of the sponsored duplicate item and the unsponsored duplicate item if the distance is less than a first threshold.

16. The system of claim 15, wherein the sponsored duplicate item and the unsponsored duplicate item have the same identifier within the content item repository.

17. The system of claim 15, wherein said discarding comprises:
identifying which of the sponsored duplicate item and the unsponsored duplicate item appears earlier in the feed than the other of the sponsored duplicate item and the unsponsored duplicate item;
discarding the sponsored duplicate item if:
the unsponsored duplicate item appears earlier and the distance is less than the first threshold; or
the sponsored duplicate item appears earlier and the distance is less than a second threshold that is less than the first threshold; and
discarding the unsponsored duplicate item if:
the sponsored duplicate item appears earlier, and the distance is greater than the second threshold and less than the first threshold.

18. The system of claim 17, wherein:
the first threshold is approximately 25; and
the second threshold is approximately 5.

19. The system of claim 15, wherein the first threshold varies according to the user.

20. The system of claim 15, wherein the first threshold varies according to a sponsor of the sponsored duplicate item.
